(19) United States
(12) Patent Application Publication
(10) Pub. No.: US 2015/0280931 A1
(43) Pub. Date: Oct. 1, 2015

(54) DATA DISTRIBUTION SYSTEM, ROOT WIRELESS DEVICE, AND WIRELESS DEVICE

(71) Applicant: Mitsubishi Electric Corporation, Chiyoda-ku, Tokyo (JP)

(72) Inventor: Toshinori Hori, Tokyo (JP)

(73) Assignee: Mitsubishi Electric Corporation, Chiyoda-ku (JP)

(21) Appl. No.: 14/429,198

(22) PCT Filed: Dec. 3, 2013
(86) PCT No.: PCT/JP2013/082467

§ 371 Date: Mar. 18, 2015

(30) Foreign Application Priority Data
Jan. 7, 2013 (JP) 2013-000507

(51) Int. Cl. H04L 12/18; H04W 74/08; H04W 4/06

(52) U.S. Cl. CPC H04L 12/189; H04W 4/06; H04W 74/0816; H04W 84/12

(57) ABSTRACT

A wireless device includes a wireless-signal reception unit that decodes a wireless signal, a wired-signal transmission and reception unit that acquires data to be distributed, a distribution-status management unit that holds a management table, a proxy-distribution determination unit that determines whether to perform retransmission of data or perform proxy distribution, a proxy-distribution wireless-device selection unit that selects a proxy-distribution wireless device, a distribution-method selection unit that selects a data distribution method of the proxy-distribution wireless device, and a wireless-signal transmission unit that modulates data and transmits a wireless signal. The wireless device includes a storage unit that stores decoded data, a proxy distribution unit that distributes data in the storage unit to low-order wireless devices, a retransmission determination unit that determines whether to retransmit data or send a notification of a data distribution status, and a wireless-signal transmission unit.

### FIELD

The present invention relates to a data distribution system that distributes data.

### BACKGROUND

In recent years, a market collectively referred to a term “digital signage” has been formed. In a device that displays information, the digital signage performs product advertisement, guidance, news reports, information distribution, advertising, and the like, and thus the contents thereof needs to be updated regularly. In software update or the like of the device, the contents need to be updated collectively at the same timing.

For updating the contents, a method of rewriting the contents manually by using a USB memory or a SD card, a distribution method by networking for labor-saving and immediate update, and the like can be used. Furthermore, in order to reduce the cost required for laying network cables, relocation at the time of changing a layout, and the like, there is a method in which wireless access such as WiMAX and WLAN is used. As a wireless technique, a multihop communication technique in which a terminal itself, which is represented by Zigbee® or the like, performs relay, has been put into practical use, as a method of improving user-friendliness by extending a communication distance.

For example, when a digital signage terminal is installed at each selling space in a retail store to place advertisements, the digital signage terminal needs to be installed within a communication range of a contents distribution server in order to use a WLAN technique that directly connects the digital signage terminal to the content distribution server, being an access point. Therefore, by combining the multihop communication techniques, the digital signage terminal is enabled to be installed at a place where direct connection to the content distribution server is not possible, whereby there are merits such as communication continuity due to channel redundancy and the like. By using such a connection form and distributing contents to be displayed and a schedule to each digital signage terminal, installation of the digital signage terminal can be simplified.

Note that if distribution data is distributed to terminals individually, the same distribution data is distributed for the number of terminals, which is not efficient and takes a long time for distribution. Conventionally, therefore, when the same data is collectively distributed to a plurality of terminals, multicast is generally used. In multicast communication, reliability decreases generally, because delivery confirmation of data is not performed. However, a method of improving the reliability by using a retransmission function has been known. That is, each terminal that has received multicast data individually returns a reception response, and a server that transmits multicast data retransmits the multicast data according to need by checking the reception response.

Patent Literatures 1 and 2 mentioned below disclose a technique such that, when data is distributed by multihop, a repeater accumulates data from a distribution server, and the repeater distributes data by proxy according to an instruction from the distribution server, thereby reducing traffic. The repeater that performs proxy distribution distributes data by multicast as in the distribution server, and uses the retransmission function of multicast communication described above.

### CITATION LIST

### Patent Literatures

Patent Literature 1: Japanese Patent Application Laid-open No. 2000-324155

Patent Literature 2: Japanese Patent Application National Publication No. 2004-512769

### SUMMARY

### Technical Problem

However, according to the conventional technique described above, if a plurality of terminals have not received all the data, the data that have not been received do not always match for each of the terminals. Therefore, there is a problem in that, if retransmission is performed individually to each terminal, retransmission traffic can increase. The retransmission traffic is required only by the terminal that has not received the data, and is not required by many other terminals.

The present invention has been achieved in view of the above problems, and an object of the present invention is to provide a data distribution system that can reduce retransmission traffic when distributing data by multicast.

### Solution to Problem

In order to solve the aforementioned problems, a data distribution system is constructed in such a manner as to include a route wireless device being a route access point and a plurality of wireless devices that can receive data directly from the route wireless device or via another wireless device, thereby to constitute a tree-structure wireless network with the route wireless device being an apex, wherein the route wireless device includes a wireless-signal reception unit that receives and decodes a wireless signal from the plurality of wireless devices, a data acquisition unit that acquires data distributed from a distribution server, a distribution-status management unit that generates and holds a management table for managing a configuration of the wireless network and a distribution status of data, based on connection information and reception responses from low-order wireless devices being the plurality of wireless devices, a proxy-distribution determination unit that determines whether to instruct retransmission of data or cause another wireless device to perform proxy distribution of data based on the management table, a proxy-distribution wireless-device selection unit that selects a wireless device that is caused to perform proxy distribution based on the management table, and executes control to instruct proxy distribution to the proxy-distribution wireless device, a distribution-method selection unit that selects a data distribution method of the proxy-distribution wireless device and executes control to instruct the data distribution method to the proxy-distribution wireless device, and a wireless-signal transmission unit that modulates data to be distributed and transmits a wireless signal, and wherein the wireless devices each includes: a wireless-signal reception unit that receives a wireless signal transmitted from the route wireless device or another wireless device and decodes the wireless signal to data, a storage unit that stores decoded data, a proxy distribution unit that controls the distribution of data stored in the storage unit to low-order wireless devices, each connected to the wireless device itself above, with control of the distribution being in accordance with a data distribution method instruction and a proxy distribution unit from the route wireless device, a retransmission determination unit that determines whether to retransmit data or send a notification of a data distribution status to the route wireless device, based on a number of hops required for the proxy distribution instruction from the route wireless device and a reception status of the distributed data in the low-order wireless devices, and a wireless-signal transmission unit that modulates data to be distributed, connection information with other wireless devices, and a reception response with respect to received data and transmits a wireless signal.

### Advantageous Effects of Invention

The data distribution system according to the present invention can reduce retransmission traffic at the time of distributing data by multicast.

### BRIEF DESCRIPTION OF DRAWINGS

FIG. 1 shows a configuration example of a data distribution system.

FIG. 2 shows a configuration example of a wireless device that is a route AP.

FIG. 3 shows a configuration example of a wireless device that is not a route AP.

FIG. 4 shows a configuration example of a management table.

FIG. 5 is a flowchart showing a process of selecting a proxy-distribution wireless device.

FIG. 6 is a flowchart showing a process of selecting a data distribution method.

### DESCRIPTION OF EMBODIMENTS

Exemplary embodiments of a data distribution system according to the present invention will be explained below in detail with reference to the accompanying drawings. The present invention is not limited to the embodiments.

### First Embodiment

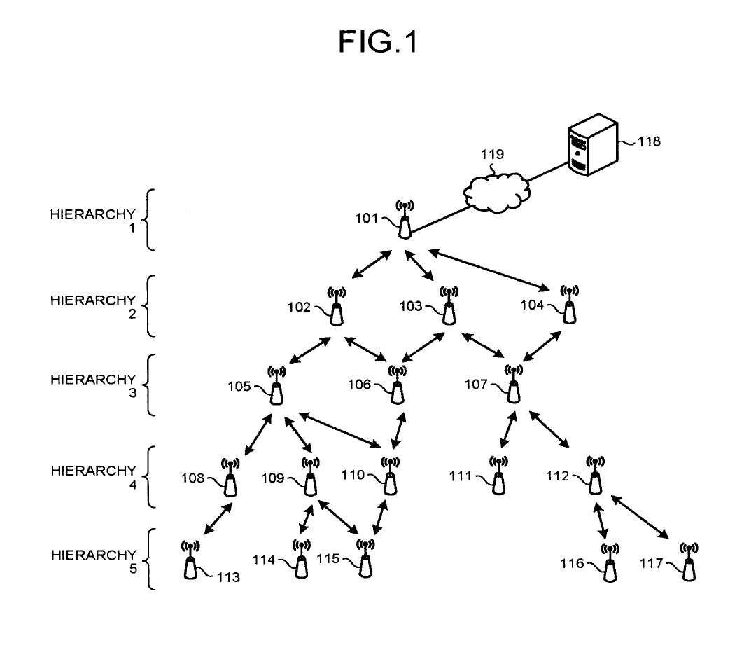

FIG. 1 shows a configuration example of a data distribution system according to a first embodiment of the present invention. The data distribution system includes wireless devices 101 to 117, a distribution server 118, and a wired network 119. The wireless devices 101 to 117 form a wireless network capable of performing multihop communication. It is assumed here that the wireless network has a tree structure, and is sequentially connected to a wireless device having a less number of wireless transfers to the wired network 119. In FIG. 1, the wireless device 101 connected to the wired network 119 is referred to as “route AP (Access Point)”. The wireless device 101 is connected to the distribution server 118 via the wired network 119 to receive distribution of data from the distribution server 118.

In FIG. 1, the wireless devices 102, 103, and 104 are connected to the wireless device 101, the wireless devices 105 and 106 are connected to the wireless device 102, the wireless devices 106 and 107 are connected to the wireless device 103, and the wireless device 107 is connected to the wireless device 104. The wireless device 106 is connected to the wireless devices 102 and 103, and the wireless device 107 is connected to the wireless devices 103 and 104. However, routing in unicast communication is decided by using an AODV (Ad hoc On-Demand Distance Vector), which is an existing routing protocol, or the like. It is assumed here that those wireless devices 101 to 117 perform communication by using CSMA/CA (Carrier Sense Multiple Access/Collision Avoidance).

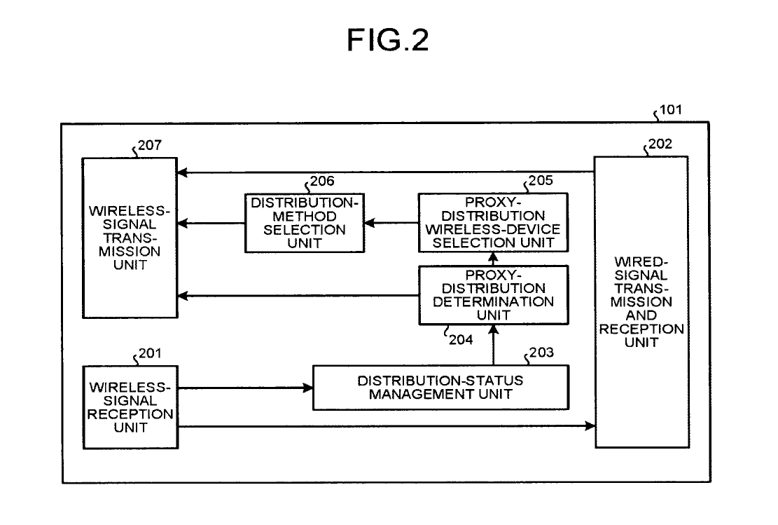

A configuration of the wireless devices is explained next. FIG. 2 shows a configuration example of the wireless device 101 that is a route AP. The wireless device 101 includes a wireless-signal reception unit 201, a wired-signal transmission and reception unit 202, a distribution-status management unit 203, a proxy-distribution determination unit 204, a proxy-distribution wireless-device selection unit 205, a distribution-method selection unit 206, and a wireless-signal transmission unit 207.

The wireless-signal reception unit 201 receives a wireless signal from another wireless device (a low-order wireless device) and decodes the signal to data. It is assumed that the wireless signal includes connection information, a reception response, and the like. The wired-signal transmission and reception unit 202 transmits and receives data to/from the wired network 119. The distribution-status management unit 203 generates and holds a management table for managing a network configuration and a distribution status of data based on the connection information and information of a reception status (a reception response) of data from the low-order wireless device. The proxy-distribution determination unit 204 determines whether to instruct the low-order wireless device to retransmit data or instruct another wireless device to perform proxy distribution, based on the management table in the distribution-status management unit 203. The proxy-distribution wireless-device selection unit 205 executes control to select a wireless device to perform proxy distribution and instruct the proxy-distribution wireless device to perform proxy distribution based on the management table in the distribution-status management unit 203. The distribution-method selection unit 206 executes control to select a data distribution method for the wireless device selected as the proxy-distribution wireless device and instruct the data distribution method to the proxy-distribution wireless device. The wireless-signal transmission unit 207 modulates data and transmits a wireless signal.

In the wireless device 101, the wired-signal transmission and reception unit 202 is enabled to transmit and receive data to/from the wired network 119. However, it suffices that the wireless device at least acquires data to be distributed from the distribution server 118. The wireless device 101 acquires the data to be distributed from the distribution server 118 via the wired network 119. However, the acquisition method is not limited thereto, and the wireless device 101 can acquire the data via a wireless network.

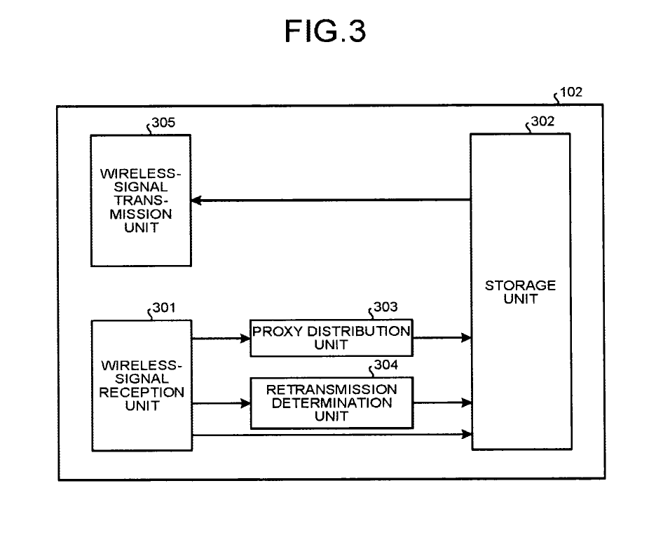

FIG. 3 shows a configuration example of the low-order wireless devices 102 to 117 constituting a tree structure of a wireless network, neither of which is a route AP. The wireless device 102 is explained as an example. However, the other wireless devices 103 to 117 have the same configuration. The wireless device 102 includes a wireless-signal reception unit 301, a storage unit 302, a proxy distribution unit 303, a retransmission determination unit 304, and a wireless-signal transmission unit 305.

The wireless-signal reception unit 301 receives a wireless signal broadcast or individually transmitted from one or a plurality of high-order wireless devices, and decodes the wireless signal to data. The storage unit 302 stores the data decoded by the wireless-signal reception unit 301 for proxy distribution. The proxy distribution unit 303 executes control to broadcast or individually transmit the data stored in the storage unit 302 to the low-order wireless devices according to a proxy distribution instruction from the high-order wireless device. The retransmission determination unit 304 determines whether to retransmit the data or send a notification of the distribution status to the high-order wireless device, based on the number of hops for the proxy distribution instruction from the high-order wireless device and the reception status of the data in the low-order wireless devices. The wireless-signal transmission unit 305 modulates the data, connection information with other wireless devices, a reception response with respect to the received data, and the like, and transmits a wireless signal.

The high-order wireless device means a wireless station constituting a wireless network in a hierarchical layer thereinafter may be referred to just as a “hierarchy”) higher than that of the wireless device itself, and the low-order wireless device means a wireless station constituting a wireless network in a hierarchy lower than that of the wireless device itself. However, between two wireless devices in different hierarchies, the device in the higher hierarchy may be referred to as “high-order wireless device”, and the device in the lower hierarchy may be referred to as “low-order wireless device”.

Subsequently, in the data distribution system, an operation after the power supplying to the respective wireless devices is started until the constitution of the wireless network shown in FIG. 1 is completed is explained, assuming that data is distributed. Because the operation of constituting the wireless network can be a general operation conventionally performed, it is briefly explained below.

First, the wireless device 101 periodically transmits a notification signal after power is supplied. Information indicating that the wireless device 101 itself is a route AP is added to the notification signal to be transmitted.

Next, power is supplied to the wireless devices 102 to 117. Upon reception of the notification signal, the wireless devices 102, 103, and 104 located in a range in which the notification signal transmitted by the wireless device 101 can be received perform authentication with the wireless device 101 or an authentication server (not shown) being present in the network, and the wireless devices 102, 103, and 104 are connected to the wireless device 101. The wireless devices 102, 103, and 104 periodically transmit the notification signal after being connected to a route AP (the wireless device 101). Information indicating that the wireless devices 102, 103, and 104 themselves are in a group in a hierarchy 2 is added to the notification signal to be transmitted.

Upon reception of the notification signal in the hierarchy 2, which is transmitted by the wireless device 102 or the like, the wireless devices 105, 106, and 107 being present at a position, where the notification signal transmitted by the wireless device 101 cannot be received, perform authentication with the wireless device in the hierarchy 2 or an authentication server (not shown) being present in the network, and the wireless devices 105, 106, and 107 are connected to the wireless device in the hierarchy 2. The wireless devices 105, 106, and 107 periodically transmit the notification signal after being connected to the wireless device in the hierarchy 2. Information indicating that the wireless devices 105, 106, and 107 themselves are in a group in a hierarchy 3 is added to the notification signal to be transmitted.

A network having a hierarchical structure is constituted in the same manner in the following hierarchies. Upon reception of the notification signal in the hierarchy 3 transmitted by the wireless device 105 or the like, the wireless devices 108, 109, 110, 111, and 112 being present at a position, where the notification signal transmitted by the wireless device 101 cannot be received, perform authentication with the wireless device in the hierarchy 3 or an authentication server (not shown) being present in the network, and the wireless devices 108, 109, 110, 111, and 112 are connected to the wireless device in the hierarchy 3. The wireless devices 108, 109, 110, 111, and 112 periodically transmit the notification signal after being connected to the wireless device in the hierarchy 3. Information indicating that the wireless devices 108, 109, 110, 111, and 112 themselves are in a group in a hierarchy 4 is added to the notification signal to be transmitted.

Upon reception of the notification signal in the hierarchy 4 transmitted by the wireless device 108 or the like, the wireless devices 113, 114, 115, 116, and 117 being present at a position, where the notification signal transmitted by the wireless device 101 cannot be received, perform authentication with the wireless device in the hierarchy 4 or an authentication server (not shown) being present in the network, and the wireless devices 113, 114, 115, 116, and 117 are connected to the wireless device in the hierarchy 4. The wireless devices 113, 114, 115, 116, and 117 periodically transmit the notification signal after being connected to the wireless device in the hierarchy 4. Information indicating that the wireless devices 113, 114, 115, 116, and 117 themselves are in a group in a hierarchy is added to the notification signal to be transmitted.

In the hierarchy 3, the wireless device 106 can detect the notification signal from the wireless devices 102 and 103, and the wireless device 107 can detect the notification signal from the wireless devices 103 and 104. Therefore, the wireless devices 106 and 107 respectively belong to two high-order wireless devices, to thereby ensure a plurality (in this case, two) of channels. The same applies to the wireless device 110 in the hierarchy 4 and the wireless device 115 in the hierarchy 5. Routing of unicast communication is decided by using the AODV, which is an existing routing protocol, or the like.

After construction of the wireless network having the hierarchy structure, the wireless devices 102 to 117 notify the wireless device 101 being a route AP, of the connection information.

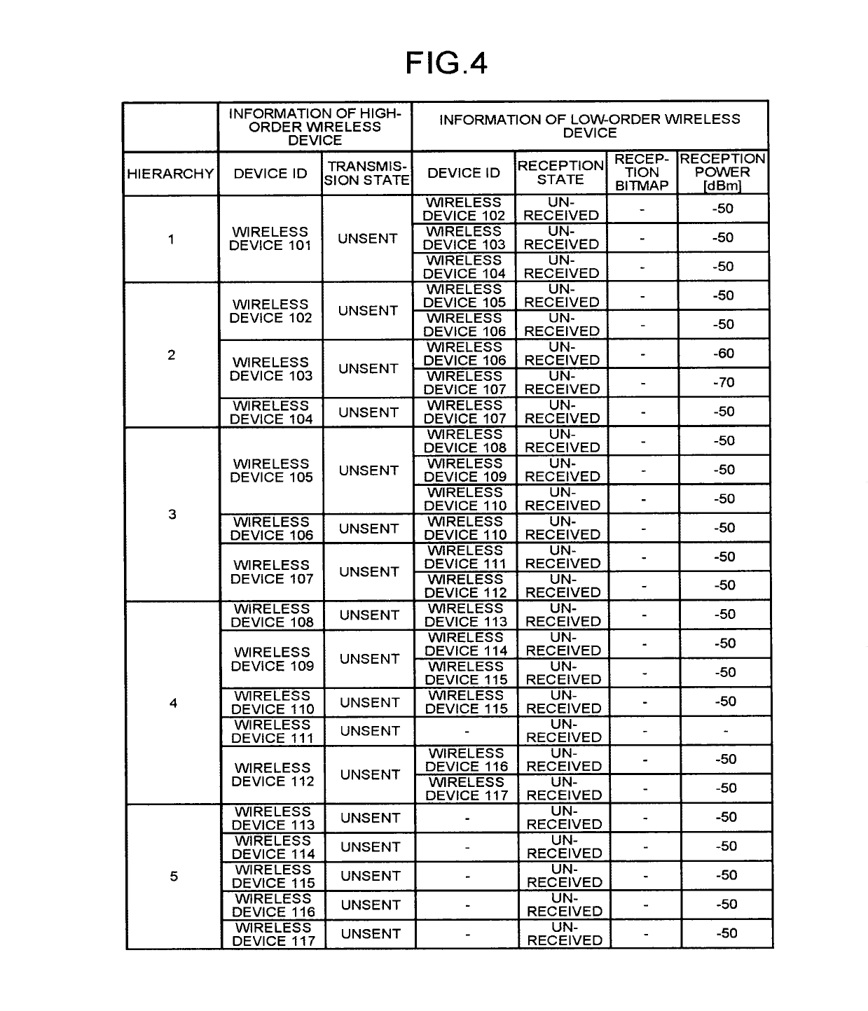

Upon reception of the connection information from the wireless devices 102 to 117, the wireless device 101 creates a management table shown in FIG. 4 in the distribution-status management unit 203. FIG. 4 shows a configuration example of the management table. It is assumed that a device ID of the wireless device managed by the management table is a MAC address unique to the wireless device. In the management table, pieces of information on a transmission state and a reception state between the high-order wireless device and the low-order wireless device connected with each other, a Bitmap (a reception Bitmap) of received data, and on reception power are managed for each hierarchy.

The distribution-status management unit 203 manages the transmission state by “unsent” (initial state) or “complete” in the management table. The distribution-status management unit 203 manages the reception state by “unreceived” (initial state), “incomplete”, or “complete”. The reception Bitmap is a response (a reception response) transmitted by the respective wireless devices when data is distributed from the high-order wireless device. The reception power is power at the time of receiving data from the high-order wireless device, which is notified periodically.

Subsequently, a data distribution method and a proxy distribution method when the wireless device 101 sequentially distributes data in the data distribution system are explained.

First, the wireless device 101 transmits data acquired by the wired-signal transmission and reception unit 202 from the distribution server 118, by multicast from the wireless-signal transmission unit 207. At this time, the wireless-signal transmission unit 207 adds a common sequence number to the data to be transmitted so that whether a reception response from the wireless device that has received the data and the received data are duplicated can be determined. The distribution-status management unit 203 updates the transmission state from “unsent” to “complete” in the item of the hierarchy 1 in the management table.

As explained for the configuration of the wireless device 101 in FIG. 2, actually, the wireless device 101 modulates the data to be distributed to the wireless signal in the wireless-signal transmission unit 207, and then transmits the data. However, to simplify the explanation, it is assumed and explained here that the wireless device 101 transmits and receives “data”. The same applies to the wireless devices 102 to 117.

In FIG. 1, the wireless devices 102, 103, and 104 can receive data transmitted by multicast from the wireless device 101. The wireless devices 102, 103, and 104 store data decoded by the wireless-signal reception unit 301 in the storage unit 302, and store “1” for received data and “0” for data not received in a bitmap.

The wireless device 101, upon completion of data transmission, individually transmits a frame for confirmation of the received data to the wireless devices 102, 103, and 104 from the wireless-signal transmission unit 207.

The wireless devices 102, 103, and 104 return (transmit a reception response) the bitmap stored in the storage unit 302 as data from the wireless-signal transmission unit 305.

Upon completion of update of the contents of the management table in the distribution-status management unit 203 based on the reception response from the wireless devices 102, 103, and 104, the proxy-distribution determination unit 204 determines to retransmit the data by the wireless device itself, and the wireless devices 101 individually retransmits data not received by the respective wireless devices from the wireless-signal transmission unit 207, thereby to complete distribution to the low-order wireless devices 102, 103, and 104 in the hierarchy immediately below the wireless device 101 itself. Upon completion of distribution, in the management table in the distribution-status management unit 203, the reception state of “information of low-order wireless device” from the respective wireless devices 102, 103, and 104 becomes “complete” in the item of the hierarchy 1.

Upon completion of distribution to the low-order wireless devices 102, 103, and 104 in the hierarchy immediately below the wireless device 101 itself, the wireless device 101 instructs the low-order wireless devices 102, 103, and 104 to perform proxy distribution. In the wireless device 101, when the proxy-distribution determination unit 204 determines to perform proxy-distribution, the proxy-distribution wireless-device selection unit 205 selects one wireless device from the wireless devices 102, 103, and 104 that have not performed proxy distribution yet, the distribution-method selection unit 206 selects a distribution method of data for the selected wireless device, and the wireless-signal transmission unit 207 issues a distribution instruction to the selected wireless device, including the data distribution method. At this time, in the wireless device 101, the distribution-status management unit 203 updates the transmission state of the selected wireless device from “unsent” to “complete” in the item of the hierarchy 2 in the management table.

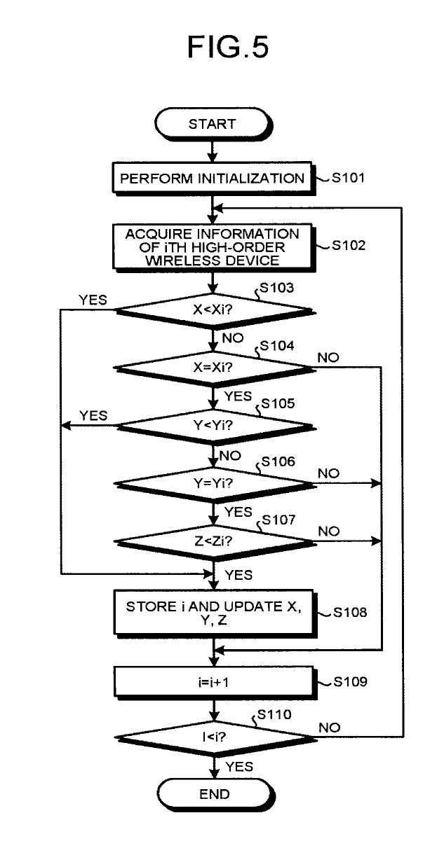

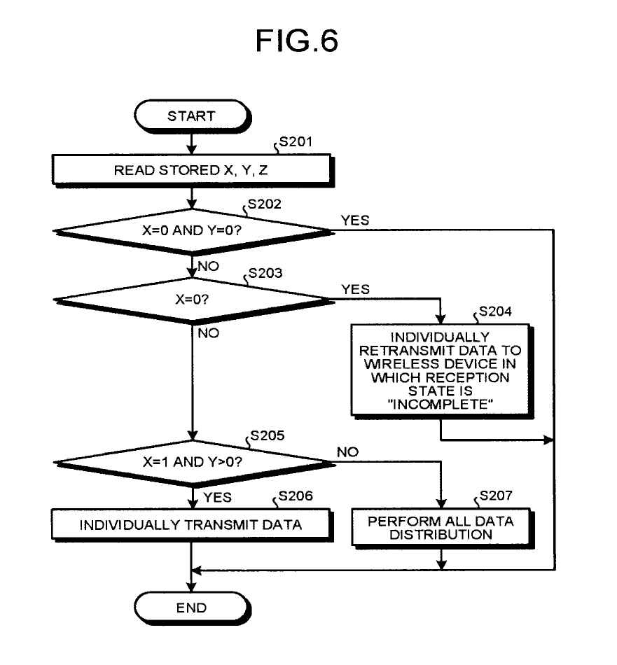

The selection method of the proxy-distribution wireless device by the proxy-distribution wireless-device selection unit 205 and the selection method of the data distribution method by the distribution-method selection unit 206 are explained with reference to flowcharts. FIG. 5 is a flowchart showing a process of selecting the proxy-distribution wireless device. FIG. 6 is a flowchart showing a process of selecting the data distribution method. The both flowcharts are only examples, and the selection processes are not limited thereto, respectively.

Respective parameters in the flowcharts in FIGS. 5 and 6 are as follows.

I: Number of high-order wireless devices in which the transmission state is “unsent”

i: Identification number of the high-order wireless device in which the transmission state is “unsent”

X: Number of stored low-order wireless devices in which the reception state is “unreceived”

Y: Number of stored low-order wireless devices in which the reception state is “incomplete”

Z: Average reception power of stored low-order wireless devices in which the reception state is “unreceived” and stored low-order wireless devices in which the reception state is “incomplete”

Xi: Number of low-order wireless devices in which the reception state is “unreceived”, which are connected to a high-order wireless device i

Yi: Number of low-order wireless devices in which the reception state is “incomplete”, which are connected to the high-order wireless device i

Zi: Average reception power of low-order wireless devices in which the reception state is “unreceived” and low-order wireless devices in which the reception state is “incomplete”, which are connected to the high-order wireless device i

Specifically, a state after the wireless device 101 completes distribution to the low-order wireless devices 102, 103, and 104 in the hierarchy immediately below the wireless device 101 is explained. At this time, in the management table shown in FIG. 4, the transmission state of the information of the high-order wireless devices has been updated to “complete”, and all the reception states of information of the low-order wireless devices has been updated to “complete”, in the item of the hierarchy 1.

In FIG. 5, upon initialization of the information stored in the proxy-distribution wireless-device selection unit 205 itself (Step S101), the proxy-distribution wireless-device selection unit 205 acquires information of the i=1st high-order wireless device (Step S102). Specifically, the proxy-distribution wireless-device selection unit 205 acquires the information of the wireless device 102 from the item of the hierarchy 2 in the management table. The pieces of information to be acquired are X1: Number of low-order wireless devices (2), in which the reception state is “unreceived”, connected to the high-order wireless device 102, Y1: Number of low-order wireless devices (0) in which the reception state is “incomplete”, connected to the high-order wireless device 102, and Z1: Average reception power (−50) of the low-order wireless devices in which the reception state is “unreceived” and the low-order wireless devices in which the reception state is “incomplete”, connected to the high-order wireless device 102.

Because there is no stored information, the proxy-distribution wireless-device selection unit 205 sets X<X1 (YES in step S103), to store i=1, and updates X1, Y1, and Z1 acquired regarding the wireless device 102 to X, Y, and Z (Step S108). The information stored therein at this time is i=1 (the wireless device 102), and (X, Y, Z)=(2, 0, −50).

The proxy-distribution wireless-device selection unit 205 increments the count of i by 1 to set i=2 (Step S109). Because i=2 is smaller than the number I=3 of the high-order wireless devices in which the transmission state is “unsent” (I>i) (NO in step S110), the process returns to Step S102, to acquire information of the i=2nd high-order wireless device (Step S102).

Specifically, the proxy-distribution wireless-device selection unit 205 acquires the information of the wireless device 103 from the item of the hierarchy 2 in the management table. The pieces of information to be acquired are X2: Number of low-order wireless devices (2) in which the reception state is “unreceived”, connected to the high-order wireless device 103, Y2: Number of low-order wireless devices (0) in which the reception state is “incomplete”, connected to the high-order wireless device 103, and Z2: Average reception power (−65) of the low-order wireless devices in which the reception state is “unreceived” and the low-order wireless devices in which the reception state is “incomplete”, connected to the high-order wireless device 103.

The proxy-distribution wireless-device selection unit 205 compares X with X2. Because both X and X2 are “2” and X=X2 (NO in step S103, YES in step S104), the proxy-distribution wireless-device selection unit 205 compares Y with Y2. Because both Y and Y2 are “0” and Y=Y2 (NO in step S105, YES in step S106), the proxy-distribution wireless-device selection unit 205 then compares Z with Z2 (Step S107).

Because Z>Z2 (NO in step S107), the proxy-distribution wireless-device selection unit 205 increments the count of i by 1 to set i=3 (Step S109). Because i=3 is the same as the number I=3 of the high-order wireless devices in which the transmission state is “unsent” (I=i) (NO in step S110), the process returns to Step S102, to acquire information of the i=3rd high-order wireless device (Step S102).

Specifically, the proxy-distribution wireless-device selection unit 205 acquires the information of the wireless device 104 from the item of the hierarchy 2 in the management table. The pieces of information to be acquired are X3: Number of low-order wireless devices (1), in which the reception state is “unreceived”, connected to the high-order wireless device 104, Y3: Number of low-order wireless devices (0) in which the reception state is “incomplete”, connected to the high-order wireless device 104, and Z3: Average reception power (−50) of the low-order wireless devices in which the reception state is “unreceived” and the low-order wireless devices in which the reception state is “incomplete”, connected to the high-order wireless device 104.

When comparing X with X3, because X>X3 (NO in step S103, NO in step S104), the proxy-distribution wireless-device selection unit 205 increments the count of i by 1 to set i=4 (Step S109), and the process ends because I<i (YES in step S110). At this time, the information stored by the proxy-distribution wireless-device selection unit 205 is information of the wireless device 102 having i=1. Therefore, the proxy-distribution wireless-device selection unit 205 selects the wireless device 102 as the wireless device to perform proxy distribution. At this time, the information stored therein is (X, Y, Z)=(2, 0, −50).

In step S105, if Y<Yi, that is, the high-order wireless device currently being determined has a larger number of low-order wireless devices in which the reception state is “incomplete” than the stored wireless device (YES in step S105), or in step S107, if Z>Zi, that is, the high-order wireless device currently being determined has larger average reception power of the low-order wireless devices in which the reception state is “unreceived” and the low-order wireless devices in which the reception state is “incomplete” than the stored wireless device (YES in step S107), the proxy-distribution wireless-device selection unit 205 updates the information stored therein to the information of the high-order wireless device currently being determined (Step S108). In step S106, if the number of Y and the number of Yi are not equal, that is, the high-order wireless device currently being determined has a smaller number of low-order wireless devices in which the reception state is “incomplete” than the stored wireless device (NO in step S106), the proxy-distribution wireless-device selection unit 205 increments the count of i by 1 (Step S109).

In FIG. 6, the distribution-method selection unit 206 reads the information of X, Y, and Z stored in the proxy-distribution wireless-device selection unit 205 (Step S201). As explained above, the information stored therein is (X, Y, Z)=(2, 0, −50).

Because X=2 (NO in step S202, NO in step S203, NO in step S205), the distribution-method selection unit 206 selects to transmit all the pieces of data, that is, to distribute the data by multicast (Step S207).

If X≠0 and Y≠0 (NO in step S202), but X=0 (YES in step S203), the distribution-method selection unit 206 selects a method of individually retransmitting data to the wireless devices in which the reception state is “incomplete” (Step S204). If X≠0 and Y≠0 (NO in step S202), but X=1 and Y>0 (NO in step S203, YES in step S205), the distribution-method selection unit 206 selects a method of individually transmitting data to the low-order wireless device (Step S206). If X=0 and Y=0 (YES in step S202), because there is no wireless device in which the reception state is “unreceived” or “incomplete”, that is, distribution of data is complete, the distribution-method selection unit 206 does not select any distribution method.

The wireless device 101 instructs the wireless device 102, which is the proxy-distribution wireless device selected by the proxy-distribution wireless-device selection unit 205 according to the method described above, to perform proxy distribution according to the data distribution method selected by the distribution-method selection unit 206, via the wireless-signal transmission unit 207.

Upon reception of the distribution instruction from the wireless device 101, the wireless device 102 transmits by multicast the data having being received from the wireless device 101 and stored in the storage unit 302 from the wireless-signal transmission unit 305 under control of the proxy distribution unit 303. At this time, the wireless-signal transmission unit 305 adds a common sequence number to the data to be transmitted, so that whether the pieces of received data from a plurality of wireless devices are duplicated can be determined.

In FIG. 1, the wireless devices 105 and 106 can receive data transmitted by multicast from the wireless device 102. The wireless devices 105 and 106 store data decoded by the wireless-signal reception unit 301 in the storage unit 302, and store “1” for the data that could be received and “0” for the data that could not be received in a bitmap.

Upon completion of data transmission, the wireless device 102 transmits a frame for confirmation of the received data to the wireless devices 105 and 106 individually from the wireless-signal transmission unit 305.

The wireless devices 105 and 106 return (transmit a reception response) the bitmap stored in the storage unit 302 as data from the wireless-signal transmission unit 305.

The wireless device 102 sends a notification of transmission completion to the wireless device 101 from the wireless-signal transmission unit 305 by adding the information of the data that could not be received by the wireless devices 105 and 106, under control of the retransmission determination unit 304.

In the wireless device 101, because the wireless device 105 can receive data only by distribution from the wireless device 102 based on the information of data that could not be received from the wireless device 102 and the management table in the distribution-status management unit 203, the proxy-distribution wireless-device selection unit 205 decides to cause the wireless device 102 to retransmit data to the wireless 105. Since the wireless device 106 can receive data by distribution from the wireless devices 102 and 103, and the wireless device 103 needs to distribute data for the wireless device 107, the wireless device 106 can achieve identical effects as retransmission by data distribution from the wireless device 103. Therefore, the proxy-distribution wireless-device selection unit 205 decides not to cause the wireless device 102 to retransmit data to the wireless device 106.

The wireless device 101 sends a notification to the wireless device 102 to retransmit data to the wireless device 106 from the wireless-signal transmission unit 207.

Upon reception of the notification from the wireless device 101, the wireless device 102 completes retransmission to the wireless device 105, and sends a notification of transmission completion to the wireless device 101.

Upon reception of the notification of transmission completion from the wireless device 105, the wireless device 101 updates the management table in the distribution-status management unit 203. The distribution-status management unit 203 updates the transmission state of the wireless device 102 in the information of the high-order wireless devices to “complete”, and updates the reception state of the wireless device 105 in the information of the low-order wireless device to “complete” in the hierarchy 2.

In the above example, the wireless device 101 transmits a distribution instruction to the wireless device 102. However, it is known to the wireless device 101 that the wireless device 105 can receive data only from the wireless device 102. Therefore, the wireless device 101 can include a device ID of the wireless device to which retransmission needs to be performed, that is, the information of the MAC address of the wireless device 105 in the notification at the time of transmitting the distribution instruction to the wireless device 102, so as to issue an instruction beforehand to perform retransmission if there are pieces of data that cannot be received by the wireless device 105. Consequently, an overhead of the retransmission instruction to a wireless device that does not have a plurality of channels can be reduced in a wireless network.

In the above example, the wireless device 102 notifies the wireless device 101 of the information of data that could not be received by the wireless devices 105 and 106. However, in the wireless device 102, the retransmission determination unit 304 can determine independently to retransmit data based on a relation between the number of hops to the wireless device 101 and a data amount to be retransmitted. Consequently, in a case in which multi-step hopping is required in order to send a notification to the wireless device 101 and the time for retransmitting data is short, the overhead of the retransmission instruction can be reduced.

As explained above, the wireless device 101 then selects a wireless device to perform proxy distribution next according to the selection method based on the flowchart shown in FIG. 5. In this case, the wireless device 101 selects the wireless device 103 as the proxy-distribution wireless device. The distribution method is also selected based on the flowchart shown in FIG. 6 as described above.

When the wireless device 103 distributes data in the same manner as the wireless device 102, the wireless device 107 receives the data for the first time. However, the wireless device 106 can receive the data that could not be received from the wireless device 102. Accordingly, the traffic can be decreased by the amount of data to be retransmitted from the wireless device 102.

However, if there are pieces of data that cannot be received by the wireless device 106 after distribution of data, the wireless device 103 notifies the wireless device 101 of this matter as in the case of the wireless device 102.

The wireless device 101 is, in the proxy-distribution determination unit 204, aware of the fact that the wireless device 106 can receive data by distribution from the wireless devices 102 and 103; however, because these two wireless devices have already distributed data, the wireless device 106 cannot receive the data even if another wireless device performs proxy distribution. The proxy-distribution determination unit 204 determines to cause proxy distribution to be performed.

In this case, in the wireless device 101, the proxy-distribution wireless-device selection unit 205 selects a wireless device (in this case, the wireless device 102) having excellent communication quality with the wireless device 106 out of the wireless devices 102 and 103 connected to the wireless device 106, and the wireless device 101 issues an instruction to retransmit only the data that has not been received by the wireless device 106. Accordingly, the wireless device 106 can eventually receive all pieces of data.

At the time of distribution of data, if there are pieces of data that cannot be received by the wireless device 107, the wireless device 103 notifies the wireless device 101 of this matter as described above.

The wireless device 101 is, in the proxy-distribution determination unit 204, aware of the fact that the wireless device 107 can receive data by distribution from the wireless devices 103 and 104; however, the wireless device 103 has already distributed data, and the wireless device 107 is only the wireless device to receive data from the wireless device 104, and thus if the wireless device 104 distributes all the pieces of data, the pieces of data that have been already received by the wireless device 107 are made useless. The proxy-distribution determination unit 204 determines to cause proxy distribution to be performed.

Accordingly, in the wireless device 101, the proxy-distribution wireless-device selection unit 205 selects a wireless device (in this case, the wireless device 104) having excellent communication quality with the wireless device 107 out of the wireless devices 103 and 104 connected to the wireless device 107, and the wireless device 101 issues an instruction to retransmit only the data that has not been received by the wireless device 107. Accordingly, the wireless device 107 can eventually receive all pieces of data.

As explained above, according to the present embodiment, in the data distribution system, when instructing the low-order wireless device to perform proxy-distribution, the wireless device 101 being a route AP sequentially selects the proxy-distribution wireless devices sequentially based on the information of wireless devices to be connected to the low-order wireless devices, and selects the data distribution method. Accordingly, at the time of distributing data by multicast, the traffic only for retransmission can be reduced. Further, by reducing the traffic, the distribution time can be shortened. Because a hierarchy network topology having a redundant channel is constructed such that retransmission does not need to be performed, an effect of improving an arrival rate of data can be obtained due to path diversity by distribution from another wireless device.

### Second Embodiment

In the first embodiment, the wireless device 101 being a route AP manages the wireless device that distributes data next, retransmission, and the like according to the reception state of the low-order wireless devices. In a second embodiment of the present invention, when the number of multihop steps increases and a long time is required for instruction of proxy distribution and transfer of a completion notification, the role of the route AP is transferred to the low-order wireless device. The parts different from those in the first embodiment are explained.

For example, in the data distribution system shown in FIG. 1, the wireless device 101 being a route AP notifies a wireless device (in this case, the wireless device 105) to which the largest number of wireless devices in the lower hierarchy that have not received distributed data are connected, among the wireless devices in the hierarchy 3 constituting a wireless network, of a part of the management table in the distribution-status management unit 203, thereby handing over a proxy distribution instruction thereto.

In the wireless device 101, under control of the proxy-distribution wireless-device selection unit 205, the wireless device 101 extracts, from the wireless-signal transmission unit 207, information indicating that the wireless devices 108, 109, and 110 are connected to the wireless device 105, and in the lower hierarchy, the wireless device 113 is connected to the wireless device 108, the wireless devices 114 and 115 are connected to the wireless device 109, and the wireless device 115 is connected to the wireless device 110 as a part of the management table in the distribution-status management unit 203, and notifies the wireless device 105 of the information. As an example, the wireless device 101 notifies the contents of the management table up to the second hierarchy. However, if there is an even lower hierarchy, information thereof can be notified.

The wireless device 105 transmits data to the low-order wireless devices 108, 109, and 110 connected to the wireless device 105 itself by the same operation as that of the wireless device 101 of the first embodiment. After completion of the data transmission, the wireless device 105 then instructs the wireless devices 108, 109, and 110 to perform proxy distribution to the wireless devices connected thereto in the lower hierarchy thereof. The selection methods of the proxy-distribution wireless device and the data distribution method are the same as those of the first embodiment (the flowcharts in FIGS. 5 and 6). After the data transmission is complete by the wireless devices instructed to perform proxy distribution, the wireless device 105 notifies the wireless device 101 of completion of data transmission to the notified wireless devices.

As explained above, according to the present embodiment, the wireless device 101 being a route AP hands over the authority to instruct proxy distribution to the low-order wireless device. Accordingly, when the number of multihop steps increases and a long time is required for instruction of proxy distribution and transfer of completion notification and the like, the transfer time can be reduced, thereby to shorten the distribution time. By distributing the process of the route AP, the load of the wireless device 101 can be reduced.

The wireless device 101 can hand over the authority to instruct proxy distribution not only to one wireless device in the lower hierarchy but also to a plurality of wireless devices in the lower hierarchy, that is, the wireless device 101 can send the information of a part of the management table. For example, in two wireless devices in a certain hierarchy, if there is no redundancy in all the wireless devices connected thereto in an even lower hierarchy, that is, the wireless device connected to the lower hierarchy is respectively independent, the wireless device 101 can give the two wireless devices authority to instruct proxy distribution.

Specifically, as shown in FIG. 1 and FIG. 4, in the hierarchy 3 of the wireless network, there is a redundancy in the wireless devices capable of receiving data by distribution from the wireless device 105 and the wireless devices capable of receiving data by distribution from the wireless device 106. Therefore, if the wireless device 101 gives the wireless devices 105 and 106 authority to instruct proxy distribution at the same time, it becomes interference. Therefore, simultaneous distribution cannot be performed.

On the other hand, in the hierarchy 3 of the wireless network, there is no redundancy in the wireless devices capable of receiving data by distribution from the wireless device 105 and the wireless devices capable of receiving data by distribution from the wireless device 107. Therefore, even if the wireless device 101 gives the wireless devices 105 and 107 authority to instruct proxy distribution at the same time, there is no interference, and thus the wireless device 101 can perform simultaneous distribution.

For example, in the case in which information of a part of the management table is notified to the wireless device 105 as a part of the management table in the distribution-status management unit 203 from the wireless-signal transmission unit 207 under control of the proxy-distribution wireless-device selection unit 205, the wireless device 101 extracts information indicating that the wireless devices 111 and 112 are connected to the wireless device 107, and the wireless devices 116 and 117 are connected to the wireless device 112 in the lower hierarchy thereof, and notifies the wireless device 107 of the information.

In this manner, in a plurality of wireless devices in a certain hierarchy, if there is no redundancy in all the wireless devices connected to an even lower hierarchy and the wireless devices connected to the lower hierarchy are respectively independent, the wireless device 101 being a route AP can hand over the authority to instruct proxy distribution to the plurality of low-order wireless devices. Accordingly, even if the low-order wireless devices perform distribution simultaneously, there occurs no interference, and thus the distribution efficiency can be improved.

### Third Embodiment

In the first and second embodiments, a method of transmitting data from a high-order wireless device to a low-order wireless device has been explained. In a third embodiment of the present invention, with respect to a wireless device that cannot receive data from the high-order wireless device due to changes in a wireless communication status, data is transmitted from a low-order wireless device or the like of that wireless device. Parts different from those in the first and second embodiments are explained.

For example, in the wireless device 101, the distribution-status management unit 203 receives a reception response from other wireless devices. If there is a wireless device that has not transmitted a reception response with respect to data distribution from the high-order wireless device, the distribution-status management unit 203 assumes deterioration of the wireless quality or a malfunction of the wireless device, regarding the wireless device that has not transmitted a reception response. In this case, the wireless device 101 notifies the wireless devices in the higher hierarchy, the same hierarchy, and the lower hierarchy of the wireless device that has not transmitted a reception response of data added with a device ID, that is, the information of the MAC address of the wireless device that has not transmitted a reception response, from the wireless-signal transmission unit 207 under control of the proxy-distribution wireless-device selection unit 205. The wireless device in the higher hierarchy means a wireless device that is not connected normally through the wireless network shown in FIG. 1, FIG. 4, and the like, that is, a wireless device that normally does not distribute data to the wireless device that has not transmitted a reception response.

Each of the wireless devices in the higher hierarchy, the same hierarchy, and in the lower hierarchy transmits a notification signal from the wireless-signal transmission unit 305 based on the contents of the notification received from the wireless device 101. Each of those wireless devices in the higher hierarchy, the same hierarchy, and the lower hierarchy returns information indicating as to whether the notification signal has been received by the wireless device that has not transmitted a reception response, and also information of wireless quality between the wireless device that has not transmitted a reception response and each of the wireless devices itself, to the wireless device 101 as a response from the wireless-signal transmission unit 305.

In the wireless device 101, the proxy-distribution wireless-device selection unit 205 selects a wireless device having excellent wireless quality to communicate with the wireless device that has not transmitted a reception response, among the wireless devices whose notification signal has been received by the wireless device that has not transmitted a reception response, based on the responses received from each of those wireless devices. The proxy-distribution wireless-device selection unit 205 then executes control to instruct the selected wireless device to distribute data to the wireless device that has not transmitted a reception response. At this time, the wireless device instructed to distribute data can perform distribution after performing authentication with the wireless device that has not transmitted a reception response. Alternatively, a format that can be received by all the wireless devices can be prepared in advance, and data can be distributed in that format.

As explained above, according to the present embodiment, when a high-order wireless device connected through a wireless network cannot distribute data due to changes in a wireless communication status or the like, the wireless device 101 being a route AP instructs data distribution from any of wireless devices in the higher hierarchy, the same hierarchy, and the lower hierarchy of the wireless device, which has not received distributed data. Accordingly, data can be distributed even to a wireless device that cannot receive data from a wireless device in a higher hierarchy connected thereto through a wireless network.

In the first to third embodiments described above, the wireless device 101 being a route AP holds the management table and issues instructions such as proxy distribution. However, these embodiments are not limited to this configuration. For example, identical effects can be achieved by installing a control device having the same function as the wireless device 101 in a wired or wireless network. In this case, the configuration of the wireless device 101 can be a memory or a CPU similar to other wireless devices, thereby enabling to achieve cost reduction of the wireless device.

### INDUSTRIAL APPLICABILITY

As described above, the data distribution system according to the present invention is useful for distributing data by multicast and is particularly suitable for distributing contents.

### REFERENCE SIGNS LIST

101 wireless device (route AP), 102 to 117 wireless device, 118 distribution server, 119 wired network, 201 wireless-signal reception unit, 202 wired-signal transmission and reception unit, 203 distribution-status management unit, 204 proxy-distribution determination unit, 205 proxy-distribution wireless-device selection unit, 206 distribution-method selection unit, 207 wireless-signal transmission unit, 301 wireless-signal reception unit, 302 storage unit, 303 proxy distribution unit, 304 retransmission determination unit, 305 wireless-signal transmission unit.

1. A data distribution system including a route wireless device being a route access point and a plurality of wireless devices that can receive data directly from the route wireless device or via another wireless device, thereby to constitute a tree-structure wireless network with the route wireless device being an apex,
wherein
the route wireless device includes
a wireless-signal reception unit that receives and decodes a wireless signal from the plurality of wireless devices,
a data acquisition unit that acquires data distributed from a distribution server,
a distribution-status management unit that manages information on a distribution status of data, based on connection information and reception responses from low-order wireless devices being the plurality of wireless devices,
a proxy-distribution determination unit that determines whether to instruct retransmission of data or cause another wireless device to perform proxy distribution of data based on the information managed by the distribution-status management unit,
a proxy-distribution wireless-device selection unit that selects a wireless device that is caused to perform proxy distribution based on the information managed by the distribution-status management unit, and executes control to instruct proxy distribution to the proxy-distribution wireless device,
a distribution-method selection unit that selects a data distribution method of the proxy-distribution wireless device and executes control to instruct the data distribution method to the proxy-distribution wireless device, and
a wireless-signal transmission unit that modulates data to be distributed and transmits a wireless signal, and
wherein
the wireless devices each includes:
a wireless-signal reception unit that receives a wireless signal transmitted from the route wireless device or another wireless device and decodes the wireless signal to data,
a storage unit that stores decoded data,
a proxy distribution unit that controls the distribution of data stored in the storage unit to low-order wireless devices, each connected to the wireless device itself above, with control of the distribution being in accordance with a data distribution method instruction and a proxy distribution unit from the route wireless device,
a retransmission determination unit that determines whether to retransmit data or send a notification of a data distribution status to the route wireless device, based on a number of hops required for the proxy distribution instruction from the route wireless device and a reception status of the distributed data in the low-order wireless devices, and
a wireless-signal transmission unit that modulates data to be distributed, connection information with other wireless devices, and a reception response with respect to received data and transmits a wireless signal.

2. The data distribution system according to claim 1, wherein in the route wireless device, the distribution-status management unit manages the low-order wireless devices in a tree-structure hierarchy by using an identifier unique to each of the devices, to manage a transmission state between the wireless devices in each hierarchy and the low-order wireless devices, a reception state in each of the low-order wireless devices, a Bitmap of received data, and reception power.

3. The data distribution system according to claim 1, wherein in the route wireless device, the proxy-distribution wireless-device selection unit instructs retransmission beforehand to the proxy-distribution wireless device based on the information managed by the distribution-status management unit.

4. The data distribution system according to claim 1, wherein in the route wireless device, the proxy-distribution wireless-device selection unit extracts information of a wireless device, which is connected to the low-order wireless device and is in an order lower than the low-order wireless device, from the information managed by the distribution-status management unit and notifies the low-order wireless device of the information, and hands over authority to the low-order wireless device to instruct proxy distribution to the wireless device, which is connected to the low-order wireless device and in the order lower than the low-order wireless device.

5. The data distribution system according to claim 4, wherein in the route wireless device, when there is no redundancy in wireless devices, which are connected to the low-order wireless devices and in an order even lower than the low-order wireless devices, in each of the plurality of low-order wireless devices, the proxy-distribution wireless-device selection unit hands over the authority to instruct proxy distribution to the plurality of low-order wireless devices.

6. The data distribution system according to claim 1, wherein in the route wireless device, when there is a wireless device that cannot receive data from a high-order wireless device, the proxy-distribution wireless-device selection unit selects a wireless device that distributes data to the wireless device that has not received data, based on a communication state with the wireless device that has not received data, from another high-order wireless device in a higher hierarchy than the wireless device that has not received data, another wireless device in a same hierarchy as the wireless device that has not received data, or a wireless device in a lower hierarchy than the wireless device that has not received data.

7. A route wireless device in a data distribution system including the route wireless device being a route access point and a plurality of wireless devices that can receive data directly from the route wireless device or via another wireless device, to constitute a tree-structure wireless network with the route wireless device being an apex, wherein
the route wireless device comprises:
a wireless-signal reception unit that receives and decodes a wireless signal from the plurality of wireless devices;
a data acquisition unit that acquires data distributed from a distribution server;
a distribution-status management unit that manages information on distribution status of data, based on connection information and reception responses from low-order wireless devices being the plurality of wireless devices,
a proxy-distribution determination unit that determines whether to instruct retransmission of data or cause another wireless device to perform proxy distribution of data based on the information managed by the distribution-status management unit,
a proxy-distribution wireless-device selection unit that selects a wireless device that is caused to perform proxy distribution based on the information managed by the distribution-status management unit, and executes control to instruct proxy distribution to the proxy-distribution wireless device,
a distribution-method selection unit that selects a data distribution method of the proxy-distribution wireless device and executes control to instruct the data distribution method to the proxy-distribution wireless device; and
a wireless-signal transmission unit that modulates data to be distributed and transmits a wireless signal.

8. The route wireless device according to claim 7, wherein the distribution-status management unit manages the low-order wireless devices in a tree-structure hierarchy by using an identifier unique to each of the devices, to manage a transmission state between the wireless devices in each hierarchy and the low-order wireless devices, a reception state in each of the low-order wireless devices, a Bitmap of received data, and reception power.

9. The route wireless device according to claim 7, wherein the proxy-distribution wireless-device selection unit instructs retransmission beforehand to the proxy-distribution wireless device based on the information managed by the distribution-status management unit.

10. The route wireless device according to claim 7, wherein, the proxy-distribution wireless-device selection unit extracts information of a wireless device, which is connected to the low-order wireless device and is in an order lower than the low-order wireless device, from the information managed by the distribution-status management unit and notifies the low-order wireless device of the information, and hands over authority to the low-order wireless device to instruct proxy distribution to the wireless device, which is connected to the low-order wireless device and in the order lower than the low-order wireless device.

11. The route wireless device according to claim 10, wherein when there is no redundancy in wireless devices, which are connected to the low-order wireless devices and in an order even lower than the low-order wireless devices, in each of the plurality of low-order wireless devices, the proxy-distribution wireless-device selection unit hands over the authority to instruct proxy distribution to the plurality of low-order wireless devices.

12. The route wireless device according to claim 7, wherein when there is a wireless device that cannot receive data from a high-order wireless device, the proxy-distribution wireless-device selection unit selects a wireless device that distributes data to the wireless device that has not received data, based on a communication state with the wireless device that has not received data, from another high-order wireless device in a higher hierarchy than the wireless device that has not received data, another wireless device in a same hierarchy as the wireless device that has not received data, or a wireless device in a lower hierarchy than the wireless device that has not received data.

13. A wireless device in a data distribution system including a route wireless device being a route access point and a plurality of wireless devices that can receive data directly from the route wireless device or via another wireless device, to constitute a tree-structure wireless network with the route wireless device being an apex, wherein
the wireless devices each comprises:
a wireless-signal reception unit that receives a wireless signal transmitted from the route wireless device or another wireless device and decodes the wireless signal to data,
a storage unit that stores decoded data,
a proxy distribution unit that controls the distribution of data stored in the storage unit to low-order wireless devices, each connected to the wireless device itself above, with control of the distribution being in accordance with a data distribution method instruction and a proxy distribution unit from the route wireless device,
a retransmission determination unit that determines whether to retransmit data or send a notification of a data distribution status to the route wireless device, based on number of hops required for the proxy distribution instruction from the route wireless device and a reception status of the distributed data in the low-order wireless device, and
a wireless-signal transmission unit that modulates data to be distributed, connection information with other wireless devices, and a reception response with respect to received data and transmits a wireless signal.
